(19) United States
(12) Patent Application Publication
(10) Pub. No.: US 2010/0063991 A1
(43) Pub. Date: Mar. 11, 2010

(54) Information Broadcasting System

(76) Inventor: William A. O'Neil, Denver, CO (US)

Correspondence Address: William A. O'Neil, 295 Clayton St., #200, Denver, CO, 80206, US

(21) Appl. No.: 11/737,123

(22) Filed: Apr. 18, 2007

(51) Int. Cl. G06F 15/16

(52) U.S. Cl. 709/203

(57) ABSTRACT

An information broadcasting system that is fully automated and user-friendly. The system includes an Information Device that transmits a signal to a Device Server. The Device Server process the transmitted signal which includes a unique identification code for the Information Device. The information is processed by the Device Server in accordance with rules provided by the user and stored in a database. The server then transmits messages to entities previously designated by the user in formats designated by the user, such as email, pagers, text messaging, instant messaging, pre-recorded telephone messages or any other form.

### FIELD OF THE INVENTION

This invention relates to the field of information broadcasting systems and particularly to wide area network systems.

### BACKGROUND OF THE INVENTION

There are numerous devices presently in use that provide information in some manner. These devices may provide information to a user of the device, to a monitoring system, to the general public or in any number of ways. These information devices range from system monitoring devices, equipment monitoring systems, health monitors, heart monitors, environmental monitors, network monitors, home and personal equipment, emergency systems to essentially any device that is capable of providing information. This information may include out of status information, normal monitoring information, change in status, emergency situations, or any other type of information.

Presently, these devices must be personally monitored. Some may be capable of sending out an alert if they are triggered, such as in the case of fire or burglar alarms. Others may allow polling to determine the status of the device. However, these devices require human intervention in some form. Typically, a signal will go out to a dispatcher or system administrator. That person is then required to determine what action to take and to transmit information then to the appropriate entity.

These systems normally require extensive human staffing and elaborate sensors that are designed for a particular use. The cost of setting up and maintaining these systems is considerable. Also, there is always the possibility of mistakes occurring during human intervention.

Another problem with these systems is that it is difficult to customize any messages that may need to be sent in the event that a device sends a signal. Normally, this entails the use of a non-public entity that has a central telephone call center. The call operator must determine where the signal is originating from, the information that is being transmitted and the entities to be contacted in regard to that signal. In order for the instructions to be customized, a technician or support personnel must be contacted and told what and how the information should be changed.

Thus a need exists for an information broadcasting system that is relatively simple, does not requiring an extensive set-up or modification process and operates automatically without human intervention for notifying specified parties such as agencies and individuals.

### SUMMARY OF THE INVENTION

The present invention solves these and other problems by providing systems for broadcasting information through a fully automated process. These systems of the preferred embodiments are user friendly in use and in setup. These systems are extremely flexible and may be utilized in an infinite number of uses. These uses include but are not limited to almost any device that is capable of providing information, whether it be an out of status event, normal monitoring, change in environmental status, health monitoring devices, panic button systems, fire sensing systems, monitoring of at-risk individuals, home detention monitoring systems, network status monitoring, equipment status monitoring, appliance monitoring and many other types of systems. The particulars of the device providing information is not necessary to the present invention, only that is capable of sensing information.

The preferred embodiment of the present invention provides an Information Device that has a unique identification code. This device is connected through a telecommunications network or other data transmission network to a Device Server. The Information Device sends a signal transmission once it is activated to the Device Server. This signal transmission includes the unique identification code and other additional information if necessary. The Device Server then processes this signal transmission in accordance with instructions stored for that identification code. This processing can include sending messages to one or more designated entities by email, text messaging, instant messaging, paging, pre-recorded telephone messages, data transmission to another IP address or any other type of transmission.

The present invention in a preferred embodiment allows the user to customize the processing of the signals. This processing can be by telephone, email, or other types of user input, but in a preferred embodiment uses a database on the Device Server for allowing the user to input information regarding the device, the entities to be contacted, the type of contact or any other information. This information is stored in a database for that identification code of the Information Device. The Device Server then uses that information to process a transmitted signal from the device having that unique identification code.

In a preferred embodiment of the present invention, the Information Device can be any device that is capable of transmitting the unique identification code to the Device Server. The device could be a system monitoring device, network operation monitor, equipment status monitor for monitoring when equipment is out of operating ranges, appliance monitor, vending machine monitor, panic button device, fire alarm, carbon monoxide monitor, security monitor device, home detention signal, or any other type of device.

The system of this preferred embodiment is fully automated not requiring human intervention except for updates and maintenance. This eliminates the need for a human telephone call center. The user is able to install and set-up the Information Devices and system information without assistance in most cases.

These and other features of the present invention are evident from the ensuing detailed descriptions of preferred embodiments and from the drawings.

### BRIEF DESCRIPTIONS OF THE DRAWINGS

FIG. 1 is schematic of an information broadcasting system of a preferred embodiment of the present invention.

### DETAILED DESCRIPTIONS OF PREFERRED EMBODIMENTS

The present invention, in a preferred embodiment, provides an information broadcasting system. This system receives information from a device and broadcasts that information in accordance with user selected preferences. A preferred embodiment of the present invention is described below. It is to be expressly understood that this descriptive embodiment is provided for explanatory purposes only, and is not meant to unduly limit the scope of the present invention as set forth in the claims. Other embodiments of the present invention are considered to be within the scope of the claimed inventions, including not only those embodiments that would be within the scope of one skilled in the art, but also as encompassed in technology developed in the future.

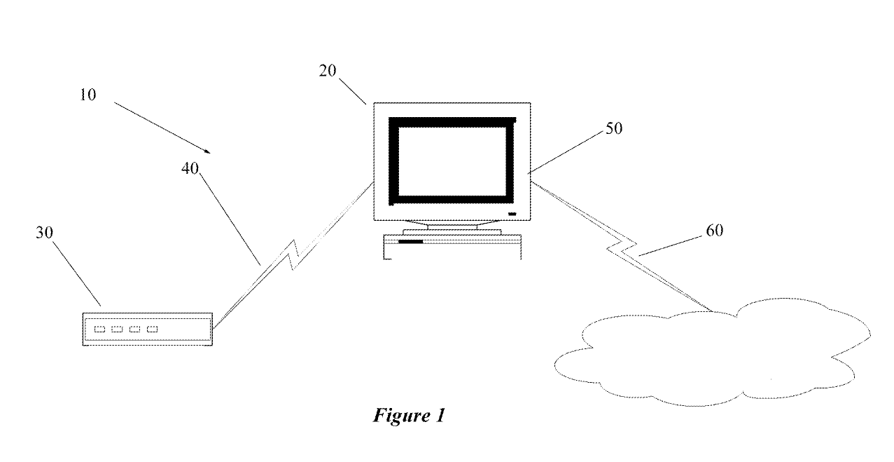

A preferred embodiment of a system of the present invention is schematically diagrammed in FIG. 1. The information broadcasting system of this preferred embodiment includes, a Device Server 20, Information Devices 30 and Communication Links 40.

The Device Server 20 can be a dedicated hardware unit, or, in the preferred embodiment, is a standard personal computer or network server. The Device Server 20 is in communication with an Information Device 30 by the Communication Links 40 such as network cables, telephone lines, by wireless telecommunications, cable systems, satellite communications or any other form of data transmission. A network card, wireless card or other suitable data transmission hardware can be installed on the Device Server 20 for interfacing with the Information Devices. In the preferred embodiment, a dedicated data transmission unit is installed on the Device Server that provides a data transmission over the Communication Links. It is to be expressly understood that other data transmission systems may be used as well as data protocols.

The Information Device 30 may be any device that is intended to provide information. This includes devices that provide status information, environmental information, alarm systems such as panic button device, a security alarm sensor, a fire sensor, carbon monoxide sensor, even health monitoring devices including heart monitors. There is no limit to the type of device or information that could be provided. It may even be a confinement sensor monitor, such as used for home detention bracelets and the like. The essential component of the Information Device 30 for purposes of the illustrative preferred embodiment of the present invention is that the Information Device contains a unique device identification and is capable for transmitting that device identification along with any additional information to the Device Server 20. The additional information can be a signal that the Information Device 30 has been activated to signal an out of status event, a change in the environmental conditions, an emergency, a break-in, a fire or any other signal that the device has been set-up to transmit. The identification itself may be a sufficient message that information is being provided for broadcast purposes. The Information Devices 30 may even be designed to monitor for activity through out the residence of an at-risk individual. If no activity has been monitored for a designated period of time, then the device may be activated to transmit a signal. In the preferred embodiment, multiple Information Devices may be used in a single system.

The Communication Links 40 provide a data transmission link between the Information Devices 30 and the Device Server. As discussed above, this data transmission link may be in the form of a wired or wireless network, direct cables, telephone links, satellite or any other form of data transmission link. The transmission may be in XML (eXtensible Markup Language) or any other type of data format. The Information Device 30 may also include multiple signal components, such as a combination panic button, security, fire, carbon monoxide and other notification systems. Each component may have a unique message or identification.

It is to be expressly understood that these described devices are provided for explanatory purposes only and are not meant to limit the scope of the claimed inventions. Any device that is capable of providing information may be covered under the present inventive concept. For example, the present invention may be used with vending machines to signal that the machine is ready to be refilled, with household appliances to signal that repairs are necessary; with automotive vehicles to signal repairs are needed; with commercial vehicles to signal improper usage or literally any device that is capable of providing information. In order for such devices to be used with the present invention, these devices simply need a unique identification and transmitting unit that recognizes when information is to be transmitted. Either the transmitting unit is built into the device, or an aftermarket transmitting unit may be installed to the device.

The system 10 may be installed by a technician or, as in the preferred embodiment, may be packaged as an off the shelf item and installed by the purchaser as described in the schematic of FIG. 2. The user simply unpackages the Information Device and connects to the desired Communication Link 40. A Device Server 20 is unpackaged and set up or, a Device Server module is installed on an existing computer or server.

Once the Information Device 30 is set up, the user can then configure the broadcast process. This can be done by the user inputting the Information Device 30 identification code, relevant details concerning the user and the broadcast rules into an Information Device Database 50 on the Device Server 20. The broadcast list may designate parties, such as individuals or agencies to be notified once the Information Device has transmitted its unique identification code, the type of broadcast (telephone call, email, pager, text message, instant message, send data to another IP address or any other type of notification), and order of the broadcast (simultaneously, sequentially, intervals, or even a roll-over list in the event that other broadcasts were not successful). This list may be modified by the user at any time by logging into the Device Server 20 and entering the appropriate information into the Device Server 20 interface.

This information is transmitted by the Device Server 20 for storage in the Information Device Database 50. The Information Device Database 50 also contains additional information such as the particulars of Information Device 50 based on the device identification including type of device, type of signal, rules to be followed and the processing of the data received from that device. This information is provided internally and updated as necessary.

Once the Information Device is activated, the system is ready to operate as described in the schematic of FIG. 3. When an event occurs that triggers the transmission mechanisms of the Information Device 30, a signal is transmitted to the Device Server 20. The transmission from the Information Device 30 is sent to the Device Server 20 via the Communication Link 40. The Device Server 20 then processes this information in accordance with the rules and information in the Device Information Database 40 based on the Information Device identification and any additional information received in the transmission. Typically, the Device Server 20 will send out messages over communication networks 60 in the form identified by the user via the Information Device Database 50. The messages may be sent by email, text messaging, instant message, paging, pre-recorded telephone, data transmission to another IP address or any other form of messaging.

The system 10 is not particularly concerned with the type or usage of the Information Devices 30. The only requirement of the system is that each device must have a unique identification and that unique identification be sent in a predefined data format such as XML. The rules dealing with a particular device, its location, its signals and other information concerning that device can be stored in the Information Device Database 50. This provides an extremely flexible system that can be configured for almost any use. Device monitoring could be sensing of out of tolerance operating ranges for appliances, status checks of appliances or vending machines, to home medical equipment, for computer networks, telecommunication device status, for emergency signal systems, home detention systems or any other type of device or information that may be applicable.

It is to be expressly understood that the above descriptive embodiments are provided for explanatory purposes only and that other embodiments are within the scope of the claimed inventions.

What is claimed is:

1. An information broadcasting system, wherein said system comprises:
an information device for transmitting a signal;
a device server for receiving a transmitted signal from said information device and processing said transmitted signal; and
a database on said device server for providing instructions to said device server for broadcasting information in accordance with the instructions.

2. The information broadcasting system of claim 1 wherein said information device includes:
a unique identification code that is transmitted in said signal.

3. The information broadcasting system of claim 1 wherein said information device includes:
said transmitted signal includes a unique identification code for said information device; and
additional information regarding said signal.

4. The information broadcasting system of claim 1 wherein said information device includes:
said transmitted signal is transmitted in XML or any other data format.

5. The information broadcasting system of claim 1 wherein said information device includes:
a communications link using a data transmission service/network for transmitting said transmitted signal.

6. The information broadcasting system of claim 1 wherein said system further includes:
a system for allowing a user to provide instructions to said database on processing said transmitted signal; and
said information including entities to be contacted and the form of contact in the event of an signal.

7. The information broadcasting system of claim 1 wherein said device server further comprises:
sending messages to entities identified in said database for said unique identification code.

8. The information broadcasting system of claim 1 wherein said device server further comprises:
a communications unit for sending messages to entities identified in said database for said unique identification code and in a form identified in said database for said unique identification code.

9. An information broadcasting system, wherein said system comprises:
an information device having a unique identification code for transmitting an signal containing said unique identification code;
a device server for receiving a transmitted signal from said information device, processing said transmitted signal and broadcasting information based on said transmitted signal to specified entities; and
a database for providing instructions based on said unique identification code to said device server on processing said transmitted signal.

10. The information broadcasting system of claim 9 wherein said information device includes:
additional information in said transmitted signal regarding said signal.

11. The information broadcasting system of claim 9 wherein said information device includes:
said transmitted signal is in XML or any other data format.

12. The information broadcasting system of claim 9 wherein said information device includes:
said transmitted signal is transmitted through a communications link using a data transmission service/network.

13. The information broadcasting system of claim 9 wherein said system further includes:
a system for allowing a user to provide information to said database on processing said transmitted signal; and
said information including entities to be contacted and form of contact in the event of an signal.

14. The information broadcasting system of claim 9 wherein said device server further comprises:
sending messages to entities identified in said database for said unique identification code; and
sending said messages to said entities in a form identified in said database for said unique identification code.

15. An information broadcasting system, wherein said system comprises:
an information device having a unique identification code for transmitting a signal containing said unique identification code;
a device server for receiving a transmitted signal from said information device, processing said transmitted signal and sending messages based on said transmitted signal to specified entities;
a database for providing instructions based on said unique identification code to said device server on processing said transmitted signal;
a user-input system for allowing a user to provide information to said database on processing said transmitted signal; and
said information including entities to be contacted and form of contact in the event of an signal.

16. The information broadcasting system of claim 15 wherein said information device includes:
said transmitted signal includes additional information regarding said signal.

17. The information broadcasting system of claim 15 wherein said information device includes:
said transmitted signal is transmitted in XML or any other data format.

18. The information broadcasting system of claim 15 wherein said information device includes:
said transmitted signal is transmitted through a communications link using a data transmission service/network.

19. The information broadcasting system of claim 15 wherein said device server further comprises:
broadcasting information to entities identified in said database for said unique identification code; and
broadcasting said information to said entities in a form identified in said database for said unique identification code.
